(19) United States
(12) Patent Application Publication
(10) Pub. No.: US 2024/0194932 A1
(43) Pub. Date: Jun. 13, 2024

(54) NONAQUEOUS SECONDARY BATTERY ELECTROLYTE, AND NONAQUEOUS SECONDARY BATTERY USING THIS

(71) Applicant: NATIONAL INSTITUTE OF ADVANCED INDUSTRIAL SCIENCE AND TECHNOLOGY, Chiyoda-ku, Tokyo (JP)

(72) Inventors: Kazushige KOHNO, Ikeda-shi, Osaka (JP); Tomonari TAKEUCHI, Ikeda-shi, Osaka (JP); Hikari SAKAEBE, Ikeda-shi, Osaka (JP)

(21) Appl. No.: 18/550,741

(22) PCT Filed: Mar. 17, 2022
(86) PCT No.: PCT/JP2022/012274

§ 371 Date: Sep. 15, 2023

(30) Foreign Application Priority Data
Mar. 19, 2021 (JP) 2021-045373

(51) Int. Cl. H01M 10/0525; H01M 4/02; H01M 4/58; H01M 10/0567; H01M 10/0568; H01M 10/0569

(52) U.S. Cl. CPC H01M 10/0525; H01M 4/5815; H01M 10/0567; H01M 10/0568; H01M 10/0569; H01M 2004/027

(57) ABSTRACT

The present invention provides an electrolyte capable of improving charge/discharge cycle performance of a nonaqueous secondary battery containing a lithium-free transition metal sulfide as a cathode active material. The electrolyte is for a nonaqueous secondary battery containing a lithium-free transition metal sulfide as a cathode active material and includes an organic solvent containing a chain carbonate compound, lithium bis(trifluoromethanesulfonyl)imide (LiTFSI), and an additive.

### TECHNICAL FIELD

The present invention relates to an electrolyte for nonaqueous secondary batteries and a nonaqueous secondary battery containing the electrolyte.

### BACKGROUND ART

With recent advancements in portable electronic devices, hybrid vehicles, and other similar equipment, there is increasing demand for high-capacity lithium-ion secondary batteries for these applications. However, the development of higher-capacity cathodes for lithium-ion secondary batteries currently lags behind the development of higher-capacity anodes. Lithium nickel oxide-based materials, which are thought to have a relatively high capacity, even have a capacity of merely about 190 mAh/g to 220 mAh/g.

Sulfur, which has a high theoretical capacity of about 1670 mAh/g, shows promise as a candidate for cathode active materials; however, such sulfur-based cathode active materials are generally known to lose their capacity after repeated charge-and-discharge cycles. This is because sulfur in the form of lithium polysulfide is dissolved into the organic electrolyte during charging and discharging. Thus, a technique for decreasing the dissolution of sulfur into organic electrolytes is required.

Lithium-free transition metal sulfides (transition metal sulfides containing no lithium) have electronic conductivity and dissolve less into organic electrolytes, but remain unsatisfactory. For example, vanadium sulfide, which is a lithium-free transition metal sulfide, can be taken as an example; crystalline vanadium (III) sulfide (V₂S₃) (commercially available reagent) used in cathode active materials cannot suppress the reaction with an organic electrolyte, giving an actual charge capacity of only about 23 mAh/g, and an actual discharge capacity of about 52 mAh/g. For this problem, the present inventors reported that a low-crystalline vanadium sulfide of a specific composition exhibits a high capacity when used in electrode active materials for lithium-ion secondary batteries and is also excellent in charge/discharge cycle performance (see, for example, PTL 1).

### CITATION LIST

### Patent Literature

PTL 1: WO2018/181698A

### SUMMARY OF INVENTION

### Technical Problem

As stated above, the present inventors developed a material that achieves a high capacity and excellent charge/discharge cycle performance when used in electrode active materials for lithium-ion secondary batteries; however, the demand for higher performance in lithium-ion secondary batteries is never-ending, requiring further improvement in charge/discharge cycle performance.

The causes of cycle degradation include the deposition of byproducts due to the reaction of a lithium-free transition metal sulfide with an electrolyte and a decrease in electrode active material components. Preventing these causes is thought to lead to improved charge/discharge cycle performance. An example of methods for suppressing the reaction between a lithium-free transition metal sulfide and an electrolyte is the use of a less reactive electrolyte.

The present invention was made in view of the current state of prior art described above, and the main object of the invention is to provide an electrolyte that can improve charge/discharge cycle performance of nonaqueous secondary batteries containing a lithium-free transition metal sulfide as a cathode active material.

### Solution to Problem

The present inventors conducted extensive research to achieve the object and found that the charge/discharge cycle performance of nonaqueous secondary batteries containing a lithium-free transition metal sulfide as a cathode active material can be further improved by adding lithium bis(trifluoromethanesulfonyl)imide (LiTFSI), an organic solvent containing a chain carbonate compound, and an additive.

The present invention was completed as a result of further research based on this finding.

Specifically, the present invention includes the following subject matter.

Item 1. An electrolyte for a nonaqueous secondary battery, the nonaqueous secondary battery comprising a lithium-free transition metal sulfide as a cathode active material, the electrolyte comprising an organic solvent containing a chain carbonate compound, lithium bis(trifluoromethanesulfonyl)imide (LiTFSI), and an additive.

Item 2. The electrolyte for a nonaqueous secondary battery according to Item 1, wherein the additive is at least one member selected from the group consisting of vinylene carbonate (VC) and fluoroethylene carbonate (FEC).

Item 3. The electrolyte for a nonaqueous secondary battery according to Item 1 or 2, wherein the content of the chain carbonate compound is two to four times the content of the lithium bis(trifluoromethanesulfonyl)imide (LiTFSI) on a molar ratio basis.

Item 4. The electrolyte for a nonaqueous secondary battery according to any one of Items 1 to 3, wherein the content of the additive is 2.5 wt % to 10 wt % based on the total amount of the electrolyte taken as 100 wt %.

Item 5. The electrolyte for a nonaqueous secondary battery according to any one of Items 1 to 4, wherein the chain carbonate compound is at least one member selected from the group consisting of dimethyl carbonate (DMC), diethyl carbonate (DEC), and ethyl methyl carbonate (EMC).

Item 6. The electrolyte for a nonaqueous secondary battery according to any one of Items 1 to 5, wherein the lithium-free transition metal sulfide is at least one member selected from the group consisting of vanadium sulfides and molybdenum sulfides.

Item 7. A nonaqueous secondary battery comprising the electrolyte for a nonaqueous secondary battery of any one of Items 1 to 6.

Item 8. The nonaqueous secondary battery according to Item 7, which is a lithium-ion secondary battery.

### Advantageous Effects of Invention

The present invention further improves the charge/discharge cycle performance of nonaqueous secondary batteries containing a lithium-free transition metal sulfide as a cathode active material.

### DESCRIPTION OF EMBODIMENTS

In the present specification, the term “comprise” includes the concepts of comprising, consisting essentially of, and consisting of. In the present specification, a numerical range “A to B” indicates A or more and B or less.

In the present specification, the concentration of each component (mol/L) indicates that a component is present in an amount of a predetermined mol per liter of an organic solvent.

### 1. Electrolyte for Nonaqueous Secondary Battery

The present invention relates an electrolyte for a nonaqueous secondary battery, the nonaqueous secondary battery comprising a lithium-free transition metal sulfide as a cathode active material, the electrolyte comprising an organic solvent containing a chain carbonate compound, lithium bis(trifluoromethanesulfonyl)imide (LiTFSI), and an additive.

### (1-1) Lithium-Free Transition Metal Sulfide

In the present invention, the transition metal sulfide for use is a lithium-free transition metal sulfide because transition metal sulfides containing lithium must be handled in an inert atmosphere, such as an argon gas atmosphere. Such a lithium-free transition metal sulfide is a transition metal sulfide containing no lithium for use in cathode active materials for nonaqueous secondary batteries that use the electrolyte for a nonaqueous secondary battery of the present invention. The lithium-free transition metal sulfide can be any lithium-free transition metal sulfide known as a cathode active material for lithium-ion secondary batteries. Specifically, lithium-free transition metal sulfides include vanadium sulfides (lithium-free vanadium sulfides; WO2018/181698A), niobium sulfides, titanium niobium sulfides (lithium-free niobium sulfides and lithium-free titanium niobium sulfides; WO2015/049986A), molybdenum sulfides (lithium-free molybdenum sulfides), and iron sulfides (lithium-free iron sulfides). The descriptions in WO2018/181698A and WO2015/049986A are incorporated by reference.

These lithium-free transition metal sulfides can be used singly, or in a combination of two or more. Of these, from the viewpoint of, for example, specific capacity and charge/discharge cycle performance, vanadium sulfides (lithium-free vanadium sulfides; WO2018/181698A), molybdenum sulfides (lithium-free molybdenum sulfides), and iron sulfides (lithium-free iron sulfides) are preferable, with vanadium sulfides (lithium-free vanadium sulfides; WO2018/181698A) being more preferable.

In the present invention, the lithium-free transition metal sulfide is preferably at least one member selected from the group consisting of vanadium sulfides and molybdenum sulfides.

These lithium-free transition metal sulfides for use may be a crystalline material or a low-crystalline material (or an amorphous material). In particular, low-crystalline materials (or amorphous materials) are preferable from the viewpoint of exceptional specific capacity, charge/discharge cycle performance, etc., as well as ease of suppressing their reaction with an organic electrolyte when the materials are in contact with the organic electrolyte.

In the present invention, the compositional ratio (S/M¹) of sulfur to a transition metal in the lithium-free transition metal sulfide is preferably within the range of 2.1 to 10 in terms of moles from the viewpoint of exceptional specific capacity, charge/discharge cycle performance, ease of synthesis, and ease of suppressing the reaction with an organic electrolyte when the lithium-free transition metal sulfide is in contact with the organic electrolyte.

More specifically, the lithium-free transition metal sulfide preferably has a composition represented by formula (2): M¹Sₓ (2) wherein M¹ represents a transition metal, and x is 2.1 to 10. When M¹ represents a plurality of transition metals, the compositional ratio (S/M¹) of sulfur to the total amount of transition metals is preferably within the range of 2.1 to 10 in terms of moles.

In the present invention, as described above, the lithium-free metal sulfide has a high ratio of a sulfur element to transition metal (M¹). Thus, the present invention can achieve a high specific capacity and excellent charge/discharge cycle performance by using a lithium-free metal sulfide. In the present invention, the higher the sulfur content (the larger x is), the more likely it is that the specific capacity will be higher, and the lower the sulfur content (the smaller x is), the less likely it is that elemental sulfur will be contained and the more likely it is that the charge/discharge cycle performance will be higher.

Due to the use of the electrolyte of composition described later, the present invention can improve charge/discharge cycle performance even with a sulfide that provides insufficient charge/discharge cycle performance. Thus, it is particularly useful to apply a polysulfide, which tends to provide a high specific capacity but tends to lead to insufficient charge/discharge cycle performance. Accordingly, x is preferably 2.1 to 10, and more preferably 3 to 8.

Below, vanadium sulfides (lithium-free vanadium sulfides), which are preferable lithium-free transition metal sulfides, are described as an example.

In the present invention, a vanadium sulfide preferably has a crystalline structure similar to that of crystalline vanadium(IV) tetrasulfide (VS₄) (which may be referred to below as a “VS₄ crystalline structure”).

More specifically, a vanadium sulfide preferably has peaks at 15.4°, 35.3°, and 45.0° in the diffraction angle range of 2θ=10° to 80° with a tolerance of ±1.0° in an x-ray pattern obtained using Cu Kα radiation. That is, the vanadium sulfide preferably has peaks in the range of 14.4° to 16.4°, 34.3° to 36.3°, and 44.0° to 46.0°.

In the present invention, the X-ray diffraction pattern is obtained by a powder X-ray diffraction method (0-20 method), and measurement is performed under the following measurement conditions:
Measuring device: D8 ADVANCE (Bruker AXS)
X-ray source: Cu Kα 40 kV/40 mA
Measurement conditions: 2θ=10° to 80°, 0.1° step,
scanning rate: 0.02°/sec.

In the present invention, a vanadium sulfide preferably has peaks at the 20 positions mentioned above, and preferably further has at least one peak at 54.0° or 56.0° (in particular, both) in the diffraction angle range of 2θ=10° to 80° with a tolerance of ±1.0°.

In the present invention, it is preferred that despite the high sulfur ratio in the average composition of a vanadium sulfide, little sulfur be present in the form of elemental sulfur as described below, and that sulfur be bound to vanadium to form a low-crystalline sulfide.

Accordingly, in the present invention, a vanadium sulfide with decreased crystallinity can have more sites in which lithium ions can be inserted and extracted, and can structurally have more defects serving as conductive pathways for lithium in three dimensions. Additionally, such a vanadium sulfide has many advantages, including the ability to easily undergo three-dimensional volume changes during charging and discharging. This further improves specific capacity and charge/discharge cycle performance. Moreover, it is also preferred that a vanadium sulfide (e.g., V₂S₃) used as a raw material be almost completely absent.

In this specification, the average composition of a sulfide refers to the ratio of the individual elements that constitute the sulfide as a whole.

The following explains the phrase “low-crystalline” in the present invention.

In the present invention, it is preferred that the low-crystalline vanadium sulfide have no peaks at 2θ=15.4°, 35.3°, and 45.0°, or that if peaks appear, the full width at half maximum of all of the peaks is 0.8 to 2.0° (in particular, 1.0 to) 2.0°. In crystalline vanadium (IV) sulfide (VS₄), the full width at half maximum of all of the peaks at 2θ=15.4°, 35.3°, and 45.0° is 0.2 to 0.6°.

Accordingly, in the present invention, it is preferred that the low-crystalline vanadium sulfide have no peaks at 2θ=15.4°, 35.3°, and 45.00, or that if peaks appear, the full width at half maximum of the peaks is larger than that of crystalline vanadium (IV) sulfide (VS₄).

Accordingly, in the present invention, low crystallinity increases the number of sites in which Li can be stably present; thus, use of a low-crystalline lithium-free metal sulfide as a cathode active material makes it easier to improve specific capacity and charge/discharge cycle performance.

The use of a material containing a large amount of elemental sulfur etc. as a cathode active material is likely to cause a reaction of the cyclic carbonate compound contained in the electrolyte for a nonaqueous secondary battery of the present invention with elemental sulfur. In the present invention, however, for example, when mechanical milling is performed for a sufficient amount of time, the vanadium sulfide described above used as a cathode active material does not cause the above problem, due to almost no content of elemental sulfur etc., even if a cyclic carbonate compound is used. Thus, the vanadium sulfide makes it easier to remarkably improve specific capacity and charge/discharge cycle performance.

More specifically, the most intense peak of sulfur (S₈) is located at 2θ=23.0° with a tolerance of ±1.0°. It is thus preferred that the vanadium sulfide does not have a peak with a local maximum at 2θ=23.0°, which is a peak characteristic of elemental sulfur, with a tolerance of ±1.0° in an x-ray pattern obtained using Cu Kα radiation. Alternatively, it is preferred that the area of the peak with a local maximum at 2θ=23.0° be 20% or less (0 to 20%, in particular, 0.1 to 19%) of the area of the peak with a local maximum at 2θ=35.3°. This allows the vanadium sulfide in the present invention to be a material that contains almost no elemental sulfur. Additionally, this also reduces the concern about causing the reaction with an electrolyte as described above and further improves specific capacity and charge/discharge cycle performance.

In the present invention, it is also preferred that the vanadium sulfide does not have peaks at positions of 2θ=25.8° and 27.8°, which are peaks characteristic of elemental sulfur, with a tolerance of ±1.0°, or that the area of peaks with local maxima at these positions is 10% or less (0 to 10%, in particular, 0.1 to 8%) of the area of the peak with a local maximum at 2θ=35.3°. This allows the vanadium sulfide to be a material that contains almost no elemental sulfur. Additionally, this also reduces the concern of causing the reaction with an electrolyte as described above and further improves specific capacity and charge/discharge cycle performance.

Vanadium sulfides satisfying the above conditions preferably have an intense peak at g (r)=2.4 Å with a tolerance of ±0.1 Å in X-ray/neutron atomic pair distribution function (PDF) analysis. Sulfides with greater specific capacity and charge/discharge cycle performance more preferably have a shoulder peak at g(r)=2.0 Å and more preferably also have a peak at g(r)=3.3 Å. In other words, the vanadium sulfide preferably has not only V—S bonds but also S—S bonds (disulfide bonds).

In the present invention, the vanadium sulfide described above can be obtained, for example, by a production method that includes the step of subjecting a vanadium sulfide and sulfur used as raw materials or intermediates to mechanical milling.

Mechanical milling is a method of milling and mixing raw materials while adding mechanical energy. This method adds a mechanical impact and friction to raw materials to mill and mix the materials, whereby a vanadium sulfide and sulfur intensely come into contact with each other and become fine particles to allow the reaction of the raw materials to proceed. That is, in this case, mixing, pulverization, and reaction occur simultaneously. This enables the reaction of the raw materials to reliably proceed without heating the raw materials to a high temperature. Mechanical milling may provide a metastable crystalline structure that cannot be obtained by ordinary heat treatment.

Specific examples of mechanical milling include mixing and pulverization using a mechanical pulverizer, such as a ball mill, a bead mill, a rod mill, a vibration mill, a disc mill, a hammer mill, or a jet mill.

These raw materials or intermediates may all be mixed together simultaneously and subjected to mechanical milling. Alternatively, after a portion of the raw materials or intermediates are first subjected to mechanical milling, the remaining materials may be added thereto and subjected to mechanical milling.

In particular, in the production of a vanadium sulfide with a high sulfur content (the compositional ratio of sulfur to vanadium (S/V) being 3.3 or more in terms of moles), a crystalline vanadium sulfide may be obtained depending on the mass to be fed. Thus, in order to easily obtain a low-crystalline vanadium sulfide with excellent specific capacity and charge/discharge cycle performance, it is preferred to first obtain a desired low-crystalline sulfide as an intermediate by subjecting a vanadium sulfide and a portion of sulfur to mechanical milling, and then subjecting the obtained low-crystalline sulfide and the remaining sulfur to mechanical milling.

Specific preferable examples of vanadium sulfides that can be used as raw materials include crystalline vanadium (III) sulfide (V₂S₃). The vanadium sulfide is not particularly limited, and any commercially available vanadium sulfide can be used. It is particularly preferable to use a high-purity vanadium sulfide. Since a vanadium sulfide is mixed and pulverized by mechanical milling, the particle size of the vanadium sulfide for use is also not limited. A commercially available vanadium sulfide powder can usually be used. For sulfur, elemental sulfur (S₈) in an amount necessary to form a sulfide of a desired composition can be used. The sulfur used as a raw material is also not particularly limited, and any sulfur can be used. It is particularly preferable to use high-purity sulfur. Since sulfur is mixed and pulverized by mechanical milling, the particle size of the sulfur for use is also not limited. A commercially available sulfur powder can usually be used.

When multiple-step (in particular, two-step) mechanical milling is applied as described above, the intermediate for use may be, for example, a low-crystalline vanadium sulfide of a desired composition (e.g., low-crystalline VS_{2.5}).

Because the ratio of the raw materials fed almost directly results in the ratio of the elements of the product, the ratio of the raw materials to be mixed may be adjusted to the elemental ratio of vanadium and sulfur in the desired vanadium sulfide. For example, sulfur is preferably used in an amount of 1.2 mol or more (in particular, 1.2 mol to 17.0 mol, and more preferably 3.0 mol to 13.0 mol) per mole of a vanadium sulfide.

The temperature at which mechanical milling is performed is not particularly limited. In order to prevent the volatilization of sulfur and the formation of the crystalline phases previously reported, the temperature during the mechanical milling is preferably 300° C. or lower, and more preferably −10 to 200° C.

The time during which mechanical milling is performed is not particularly limited. Mechanical milling can be performed for any length of time until a desired vanadium sulfide is precipitated.

The atmosphere in which mechanical milling is performed is not particularly limited and may be an inert gas atmosphere, such as a nitrogen gas atmosphere or an argon gas atmosphere.

For example, mechanical milling can be performed for 0.1 hours to 100 hours (in particular, 15 hours to 80 hours). Mechanical milling may optionally be performed multiple times with pauses in between.

When mechanical milling is performed multiple times, the above conditions can be applied in each mechanical milling step.

The mechanical milling described above can provide a desired vanadium sulfide in fine powder form.

### (1-2) Organic Solvent

The electrolyte for a nonaqueous secondary battery of the present invention comprises an organic solvent containing a chain carbonate compound, lithium bis(trifluoromethanesulfonyl)imide (LiTFSI), and an additive.

As described above, the electrolyte for a nonaqueous secondary battery of the present invention is used in nonaqueous secondary batteries containing a lithium-free transition metal sulfide as a cathode active material. Despite the use of the electrolyte in nonaqueous secondary batteries containing a lithium-free transition metal sulfide, the present invention can suppress the reaction of the chain carbonate compound with the lithium-free transition metal sulfide and dramatically improve charge/discharge cycle performance by having the additive described later added.

### Chain Carbonate Compound

The chain carbonate compound can be any chain carbonate compound usable as an organic solvent in electrolytes for lithium-ion secondary batteries. Examples of chain carbonate compounds include chain dimethyl carbonate (DMC), diethyl carbonate (DEC), and ethyl methyl carbonate (EMC). These chain carbonate compounds can be used singly, or in a combination of two or more.

In the measurement of electrical conductivity of an electrolyte containing ethylene carbonate EC (cyclic carbonate) and ethyl methyl carbonate EMC (chain carbonate) at different concentrations, the electrolyte remains in its liquid form until −40° C. at EC (cyclic)/EMC (chain)=10/90 (vol %); thus, electrical conductivity can be measured. If the ratio of the cyclic carbonate EC is increased, precipitation of EC occurs at −30° C. or lower at EC/EMC=50/50; thus, electrical conductivity cannot be measured.

For an electrolyte containing a cyclic carbonate, such as ethylene carbonate (EC) and propylene carbonate (PC), and a chain carbonate, such as ethyl methyl carbonate (EMC), diethyl carbonate (DEC), and dimethyl carbonate (DMC), the ratio of EC added is generally limited to 30% or lower in order to prevent the precipitation of LiPF₆ or EC in a low temperature range, such as −40° C.

Due to the chain carbonate contained, the electrolyte for a nonaqueous secondary battery of the present invention is advantageous at low temperatures.

In the present invention, the chain carbonate compound is preferably at least one member selected from the group consisting of dimethyl carbonate (DMC), diethyl carbonate (DEC), ethyl methyl carbonate (EMC), and methyl propyl carbonate.

In the present invention, the organic solvent for the electrolyte for a nonaqueous secondary battery may be formed only of the chain carbonate compound described above, or may also contain other compounds known as organic solvents for electrolytes of lithium-ion secondary batteries in addition to the chain carbonate compound.

Examples of organic solvents that serve as the third component as described above include cyclic carboxylic acid ester compounds, such as γ-butyrolactone; chain carboxylic acid ester compounds, such as methyl acetate, methyl propionate, and ethyl acetate; sulfone compounds, such as sulfolane and diethyl sulfone; and ether compounds, such as tetrahydrofuran, 2-methyltetrahydrofuran, and 1,2-dimethoxyethane. These organic solvents that serve as the third component can be used singly, or in a combination of two or more.

If the electrolyte for a nonaqueous secondary battery contains an organic solvent that serves as the third component, the content of the organic solvent (third component) is preferably 0.1 vol % to 10 vol %, and more preferably 0.2 vol % to 5 vol % based on the total amount of the organic solvent taken as 100 vol % from the viewpoint of charge/discharge cycle performance.

### (1-3) Additive

The electrolyte for a nonaqueous secondary battery of the present invention comprises an organic solvent containing a chain carbonate compound, lithium bis(trifluoromethanesulfonyl)imide (LiTFSI), and an additive.

As described above, due to the additive contained, the electrolyte for a nonaqueous secondary battery of the present invention can suppress the reaction of the carbonate compound with the lithium-free transition metal sulfide and dramatically improve charge/discharge cycle performance.

From the viewpoint of ease of suppressing the reaction of the carbonate compound with the lithium-free transition metal sulfide and ease of improving charge/discharge cycle performance, the additive is preferably vinylene carbonate (VC) or fluoroethylene carbonate (FEC).

The additives described above can be used singly, or in a combination of two or more. Using two or more additives in combination can improve charge/discharge cycle performance even with an increased additive content.

In the present invention, the additive is preferably at least one member selected from the group consisting of vinylene carbonate (VC) and fluoroethylene carbonate (FEC).

From the viewpoint of specific capacity, charge/discharge cycle performance, energy density, etc., the content of the additive is preferably 2.5 parts by mass to 20.0 parts by mass, more preferably 2.5 parts by mass to 15.0 parts by mass, and still more preferably 2.5 parts by mass to 10.0 parts by mass, per 100 parts by mass of the organic solvent. In regards to the use of one type of additive alone, if an additive such as fluoroethylene carbonate (FEC), trifluoromethyl ethylene carbonate, or vinyl ethylene carbonate is used alone, a larger amount of such an additive can easily improve charge/discharge cycle performance; thus, the content of such an additive is preferably 2.5 parts by mass to 10.0 parts by mass, per 100 parts by mass of the organic solvent. Even if two or more additives are used in combination in a large amount, it is still easy to improve charge/discharge cycle performance and improve energy density; thus, the total content of the additives is preferably 2.5 parts by mass to 20.0 parts by mass, more preferably 2.5 parts by mass to 15.0 parts by mass, and still more preferably 5.0 parts by mass to 10.0 parts by mass, per 100 parts by mass of the organic solvent.

### (1-4) Lithium Salt

The electrolyte for a nonaqueous secondary battery of the present invention comprises an organic solvent containing a chain carbonate compound, lithium bis(trifluoromethanesulfonyl)imide (LiTFSI), and an additive.

The electrolyte for a nonaqueous secondary battery of the present invention further contains lithium bis(trifluoromethanesulfonyl)imide (LiTFSI: Li (CF₃SO₂)₂N) as a lithium salt. This lithium salt is an organic lithium salt having a sulfonyl group (perfluoroalkane sulfonyl group). Due to the use of LiTFSI as a lithium salt, the electrolyte for a nonaqueous secondary battery can withstand charging at higher voltages and exhibit further improved charge/discharge cycle performance.

Additionally, the organic lithium salt having a sulfonyl group can be any that has been conventionally used in electrolytes for nonaqueous secondary batteries. Examples include organic lithium salts having a perfluoroalkane sulfonyl group (e.g., lithium bis(pentafluoroethanesulfonyl)imide (Li (C₂F₅SO₂)₂N)). These organic lithium salts having a sulfonyl group may be used singly, or in a combination of two or more.

From the viewpoint of charge/discharge cycle performance, the lithium salt is preferably an organic lithium salt having a sulfonyl group rather than an inorganic lithium salt (e.g., LiPF₆ and LiBF₄).

Additionally, an organic lithium salt having a boron atom may be added. From the viewpoint of charge/discharge cycle performance, the lithium salt is preferably an organic lithium salt having a boron atom.

Due to the lithium-free metal sulfide used as a cathode active material in the nonaqueous secondary battery of the present invention, the impact of its reactivity with sulfur on charge/discharge cycle performance is taken into consideration. Using LiTFSI as a lithium salt leads to excellent charge/discharge cycle performance.

In the present invention, the content of the chain carbonate compound is two to four times the content of the lithium bis(trifluoromethanesulfonyl)imide (LiTFSI) on a molar ratio basis.

From the viewpoint of charge/discharge cycle performance and internal resistance, the concentration of the lithium salt in the electrolyte for a nonaqueous secondary battery of the present invention is preferably two to four times, and more preferably 2 to 3 times higher than that of the chain carbonate on a molar ratio basis.

### (1-5) Other Components

The electrolyte for a nonaqueous secondary battery of the present invention may contain components other than those described above, such as other additives, as long as the effect of the invention is not impaired (e.g., 0.01 mol/L to 0.2 mol/L, and particularly 0.02 mol/L to 0.1 mol/L).

Examples of such other additives include tetrabutylammonium hexafluorophosphate, tetrabutylammonium perchlorate, tetramethylammonium tetrafluoroborate, tetramethylammonium chloride, tetraethylammonium chloride, tetrabutylammonium chloride, tetramethylammonium bromide, tetraethylammonium bromide, tetrabutylammonium bromide, biphenyl, and trialkyl phosphate (e.g., trimethyl phosphate). These additives can be used singly, or in a combination of two or more.

### 2. Nonaqueous Secondary Battery

The nonaqueous secondary battery of the present invention includes the electrolyte for a nonaqueous secondary battery described above. For other configurations and structures, configurations and structures used in conventionally known nonaqueous secondary batteries can be applied. Typically, the nonaqueous secondary battery of the present invention can contain a cathode, an anode, and a separator in addition to the electrolyte for a nonaqueous secondary battery.

### (2-1) Cathode

The cathode may have a configuration in which a cathode layer containing a cathode active material, a binder, etc. is formed on one surface or both surfaces of a cathode current collector.

The cathode layer can be produced through the steps of adding a binder to a cathode active material and an optional conductive material, dispersing the mixture in an organic solvent to prepare a paste for forming a cathode layer (in this case, the binder may be dissolved or dispersed in an organic solvent beforehand), applying the paste to the surface (one surface or both surfaces) of a cathode current collector made of metal foil or the like, drying the paste to form a cathode layer, and processing the cathode layer as necessary.

The cathode active material for use is the lithium-free metal sulfide described above. The details of the lithium-free metal sulfide are as explained above.

The conductive material for use can be, for example, graphite; carbon black (e.g., acetylene black and Ketjen black); amorphous carbon materials, such as carbon materials with amorphous carbon formed on the surface; fibrous carbon (vapor-grown carbon fibers, carbon fibers obtained by spinning pitches and then subjecting them to carbonization treatment, etc.); or carbon nanotubes (various types of multi-layered or single-layered carbon nanotubes) as in ordinary nonaqueous secondary batteries. The conductive material for the cathode may be a single material or a combination of two or more.

Examples of binders include polyvinylidene fluoride (PVDF), polytetrafluoroethylene, polyacrylic acid, styrene-butadiene rubber, polyimide, polyvinyl alcohol, and water-soluble carboxymethyl cellulose.

The organic solvent used in producing the cathode layer is not particularly limited, and examples include N-methylpyrrolidone (NMP). A paste may be formed from an organic solvent, a cathode active material, a binder, etc.

The composition of the cathode layer is, for example, preferably the following: the cathode active material is about 70 wt % to 95 wt % and the binder is about 1 wt % to 30 wt %. If a conductive material is used, the composition of the cathode layer is preferably the following: the cathode active material is about 50 wt % to 90 wt %, the binder is about 1 wt % to 20 wt %, and the conductive material is about 1 wt % to 40 wt %.

The thickness of the cathode layer is preferably about 1 μm to 100 μm per surface of the current collector.

The cathode current collector for use may be, for example, foil made of aluminum, stainless steel, nickel, titanium, or an alloy thereof; a punched metal; an expanded metal; or a net. Typically, aluminum foil with a thickness of about 10 μm to 30 μm is preferably used.

### (2-2) Anode

The anode may have a configuration in which an anode layer containing an anode active material, a binder, etc. is formed on one surface or both surfaces of an anode current collector.

The anode layer can be produced through the steps of mixing a binder with an anode active material and an optional conductive material to form a sheet, and pressure-bonding the sheet to the surface (one surface or both surfaces) of an anode current collector made of metal foil or the like.

The anode active material is not particularly limited, and examples include graphite (e.g., natural graphite and artificial graphite), sintering-resistant carbon, lithium metal, tin, silicon, alloys containing tin or silicon, and SiO. A lithium metal, a lithium alloy, or the like can be preferably used in metal-lithium primary batteries and metal-lithium secondary batteries. In lithium-ion secondary batteries, for example, a material that can be doped or undoped with lithium ions (e.g., graphite, such as natural graphite and artificial graphite, and sintering-resistant carbon) can be used as an active material. These anode active materials may be used singly, or in a combination of two or more.

The conductive material for use can be, for example, graphite; carbon black (e.g., acetylene black and Ketjen black); amorphous carbon materials, such as carbon materials with amorphous carbon formed on the surface; fibrous carbon (vapor-grown carbon fibers, carbon fibers obtained by spinning pitches and then subjecting them to carbonization treatment, etc.); or carbon nanotubes (various types of multi-layered or single-layered carbon nanotubes) as in ordinary nonaqueous secondary batteries. The conductive material for the anode may be a single material or a combination of two or more, or the conductive material may not be used when the anode active material has high conductivity.

Examples of binders include polyvinylidene fluoride (PVDF), polytetrafluoroethylene, polyacrylic acid, styrene-butadiene rubber, polyimide, polyvinyl alcohol, and water-soluble carboxymethyl cellulose.

The composition of the anode layer is, for example, preferably the following: the anode active material is about 70 wt % to 95 wt % and the binder is about 1 wt % to 30 wt %. If a conductive material is used, the composition of the anode layer is preferably the following: the anode active material is about 50 wt % to 90 wt %, the binder is about 1 wt % to 20 wt %, and the conductive material is about 1 wt % to 40 wt %.

The thickness of the anode layer is preferably about 1 μm to 100 μm per surface of the current collector.

The anode current collector for use may be, for example, foil made of aluminum, copper, stainless steel, nickel, titanium, or an alloy thereof; a punched metal; an expanded metal; a mesh; or a net. Typically, copper foil with a thickness of about 5 μm to 30 μm is preferably used.

### (2-3) Separator

The cathode and the anode described above are used in the form of, for example, a laminated electrode prepared by laminating the cathode and the anode with an interjacent separator between them, or in the form of a spiral-wound electrode prepared by further winding the laminated electrode into a spiral shape.

A preferable separator has sufficient strength and can retain as much electrolyte as possible. From these viewpoints, the separator is preferably a microporous film, a non-woven fabric, or the like that has a thickness of 10 μm to 50 μm and an open-pore ratio of 30% to 70%, and that contains at least one of the following: polyethylene, polypropylene, an ethylene-propylene copolymer, etc.

An example of the form of the nonaqueous secondary battery of the present invention is a tube (e.g., a rectangular prism and a cylinder) that includes a stainless steel can, an aluminum can, or the like as an outer can. A soft-pack battery that includes a laminate film integrated with metal foil as its exterior is also usable.

### EXAMPLES

The present invention is described in detail below based on Examples. However, needless to say, the present invention is not limited to the following Examples.

### Synthesis Example 1: Synthesis of Vanadium Sulfide

### (Cathode Active Material)

Commercially available vanadium (III) sulfide (V₂S₃; produced by Kojundo Chemical Laboratory Co., Ltd.) and sulfur (produced by Fujifilm Wako Pure Chemical Corporation) were weighed to give a molar ratio of 1:6 in an argon gas atmosphere in a glove box (dew point: −80° C.) and sealed in a glass tube in a vacuum.

The vacuum-sealed sample was calcined in a tubular furnace at 400° C. for 5 hours. Excess sulfur was removed by calcining the calcined sample in a vacuum at 200° C. for 8 hours to synthesize crystalline vanadium sulfide VS₄ (c-VS₄).

Subsequently, the obtained crystalline VS₄ (c-VS₄) was subjected to mechanical milling for 40 hours using a ball mill (ball diameter: 4 mm, number of revolutions: 270 rpm; PL-7, produced by Fritsch) in an argon gas atmosphere in a glove box (dew point: −80° C.) to synthesize a low-crystalline vanadium sulfide VS₄ (a-VS₄), which was used as a cathode active material.

The results of powder XRD measurement indicated no clear peak other than the minimum peak of V₂₀₃ (an extremely small amount of impurity), and the obtained low-crystalline vanadium sulfide a-VS₄ was found to be completely amorphous.

### Synthesis Example 2: Synthesis of Molybdenum Sulfide

### (Cathode Active Material)

Molybdenum sulfide was synthesized in a manner similar to the method described in a previous report (X. Wang, K. Du, C. Wang, L. Ma, B. Zhao, J. Yang, M. Li, X. Zhang, M. Xue, and J. Chen, ACS Appl. Mater. Interface, 9, 38606-38611 (2017)).

Commercially available ammonium molybdate tetrahydrate ((NH₄)₆Mo₇O₂₄·4H₂O; produced by Fujifilm Wako Pure Chemical Corporation) and hydroxylamine chloride (NH₂OH·HCl; produced by Fujifilm Wako Pure Chemical Corporation) were weighed to give a weight ratio of 4:3 in a measuring flask, and a mixture of ammonium sulfide ((NH₄)₂S; produced by Fujifilm Wako Pure Chemical Corporation) and ion-exchanged water was added dropwise thereto. The resulting mixture was then maintained at 50° C. for 1 hour and then maintained at 90° C. for 4 hours to obtain a precipitate.

The precipitate was collected by filtration and dried in an Ar gas atmosphere for 12 hours. The dried sample was subjected to heat treatment in an Ar atmosphere in an electric furnace at 220° C. for 1 hour to synthesize amorphous MoS_{5.7}.

### Details of Abbreviations

EMC: ethyl methyl carbonate
LiTFSI: lithium bis(trifluoromethanesulfonyl)imide
FEC: fluoroethylene carbonate
VC: vinylene carbonate
DMC: dimethyl carbonate
DEC: diethyl carbonate

### Example 1: FEC 2.5 Mass %/EMC: LiTFSI (Solvent 2:1 in Molar Ratio)

LiTFSI was added to an EMC solvent to give a concentration of 2:1 in molar ratio, and 2.5 parts by mass of FEC was further added to 100 parts by mass of the electrolyte mixture, thereby obtaining an electrolyte for a nonaqueous secondary battery of Example 1.

### Example 2: FEC 5 Mass %/EMC: LiTFSI (Solvent 2:1 in Molar Ratio)

LiTFSI was added to an EMC solvent to give a concentration of 2:1 in molar ratio, and 5 parts by mass of FEC was further added to 100 parts by mass of the electrolyte mixture, thereby obtaining an electrolyte for a nonaqueous secondary battery of Example 2.

### Example 3: FEC 10 Mass %/EMC: LiTFSI (Solvent 2:1 in Molar Ratio)

LiTFSI was added to an EMC solvent to give a concentration of 2:1 in molar ratio, and 10 parts by mass of FEC was further added to 100 parts by mass of the electrolyte mixture, thereby obtaining an electrolyte for a nonaqueous secondary battery of Example 3.

### Example 4: VC 2.5 Mass %/EMC: LiTFSI (Solvent 2:1 in Molar Ratio)

LiTFSI was added to an EMC solvent to give a concentration of 2:1 in molar ratio, and 2.5 parts by mass of VC was further added to 100 parts by mass of the electrolyte mixture, thereby obtaining an electrolyte for a nonaqueous secondary battery of Example 4.

### Example 5: VC 5 Mass %/EMC: LiTFSI (Solvent 2:1 in Molar Ratio)

LiTFSI was added to an EMC solvent to give a concentration of 2:1 in molar ratio, and 5 parts by mass of VC was further added to 100 parts by mass of the electrolyte mixture, thereby obtaining an electrolyte for a nonaqueous secondary battery of Example 5.

### Example 6: VC 10 Mass %/EMC: LiTFSI (Solvent 2:1 in Molar Ratio)

LiTFSI was added to an EMC solvent to give a concentration of 2:1 in molar ratio, and 10 parts by mass of VC was further added to 100 parts by mass of the electrolyte mixture, thereby obtaining an electrolyte for a nonaqueous secondary battery of Example 6.

### Example 7: FEC 10 Mass %/EMC: LiTFSI (Solvent 3:1 in Molar Ratio)

LiTFSI was added to an EMC solvent to give a concentration of 3:1 in molar ratio, and 10 parts by mass of FEC was further added to 100 parts by mass of the electrolyte mixture, thereby obtaining an electrolyte for a nonaqueous secondary battery of Example 7.

### Example 8: FEC 10 Mass %/EMC: LiTFSI (Solvent 4:1 in Molar Ratio)

LiTFSI was added to an EMC solvent to give a concentration of 4:1 in molar ratio, and 10 parts by mass of FEC was further added to 100 parts by mass of the electrolyte mixture, thereby obtaining an electrolyte for a nonaqueous secondary battery of Example 6.

### Example 9: FEC 10 Mass %/DMC: LiTFSI (Solvent 2:1 in Molar Ratio)

LiTFSI was added to a DMC solvent to give a concentration of 2:1 in molar ratio, and 10 parts by mass of FEC was further added to 100 parts by mass of the electrolyte mixture, thereby obtaining an electrolyte for a nonaqueous secondary battery of Example 9.

### Example 10: FEC 10 Mass %/DEC: LiTFSI (Solvent 2:1 in Molar Ratio)

LiTFSI was added to a DEC solvent to give a concentration of 2:1 in molar ratio, and 10 parts by mass of FEC was further added to 100 parts by mass of the electrolyte mixture, thereby obtaining an electrolyte for a nonaqueous secondary battery of Example 10.

### Example 11: FEC 5 Mass %+VC 5 Mass %/EMC: LiTFSI (Solvent 2:1 in Molar Ratio)

LiTFSI was added to an EMC solvent to give a concentration of 2:1 in molar ratio, and 5 parts by mass of FEC and 5 parts by mass of VC were further added to 100 parts by mass of the electrolyte mixture, thereby obtaining an electrolyte for a nonaqueous secondary battery of Example 11.

### Example 12: FEC 10 Mass %/EMC: LiTFSI (Solvent 3:1 in Molar Ratio)

LiTFSI was added to an EMC solvent to give a concentration of 3:1 in molar ratio, and 10 parts by mass of FEC was further added to 100 parts by mass of the electrolyte mixture, thereby obtaining an electrolyte for a nonaqueous secondary battery of Example 12.

### Comparative Example 1: No Additive/EMC: LiTFSI (Solvent 2:1 in Molar Ratio)

LiTFSI was added to an EMC solvent to give a concentration of 2:1 in molar ratio, thereby obtaining an electrolyte for a nonaqueous secondary battery of Comparative Example 1.

### Comparative Example 2: No Additive/EMC: LiTFSI (Solvent 3:1 in Molar Ratio)

LiTFSI was added to an EMC solvent to give a concentration of 3:1 in molar ratio, thereby obtaining an electrolyte for a nonaqueous secondary battery of Comparative Example 2.

### Test Example 1: Evaluation of Initial Internal Resistance (Initial)

With the electrolytes for a nonaqueous secondary battery obtained in Examples 1 to 11 and Comparative Example 1, the VS₄ powder obtained in Synthesis Example 1 was used as a cathode active material.

With the electrolytes for a nonaqueous secondary battery obtained in Example 12 and Comparative Example 2, the MoS_{5.7} powder obtained in Synthesis Example 2 was used as a cathode active material.

Experimental electrochemical cells (lithium secondary battery) were produced according to the following method, and constant-current charge and discharge were performed in 2 cycles at 25° C. at a charge-discharge rate of 0.2C (1C=747 mAh/g) at a voltage within the range of 2.6 V to 1.5 V with down-time of 10 minutes between cycles.

After charging to 2.6 V, discharging was performed at 0.05C for 10 seconds, and the difference between the voltage at the start of discharging and the voltage after discharging for 10 seconds was measured. Thereafter, constant-current charging was performed to 2.6 V at 0.05C. After a down-time of 10 minutes, discharging was performed at 0.1C for 10 seconds, and the difference in voltage before and after discharging was measured in the same manner. Then, constant-current charging was performed at 0.05C to 2.6 V. After a down-time of 10 minutes, discharging was performed at 0.2C for 10 seconds, and the difference in voltage before and after discharging was measured.

The slope calculated based on a graph of the current at discharging and the difference in voltage measured after 10 seconds was defined as the initial internal resistance.

The method for producing experimental electrochemical cells was the following: first, a working electrode (cathode) was produced by adding 1 mg of Ketjen black and 1 mg of polytetrafluoroethylene (PTFE) (binder) to 10 mg of the VS₄ powder obtained in Synthesis Example 1 and mixing these components in a mortar for 8 minutes, followed by pasting the resulting mixture to an aluminum mesh.

For the counter electrode (anode), lithium metal was used.

For the separator, polypropylene was used.

Table 1 shows the results of initial internal resistance characteristics.

The lower the initial internal resistance, the lower the energy loss as a battery with greater output characteristics.

### Test Example 2: Charge-Discharge Test (after 100 Cycles)

With the electrolytes for a nonaqueous secondary battery obtained in Examples 1 to 11 and Comparative Example 1, the VS₄ powder obtained in Synthesis Example 1 was used as a cathode active material.

With the electrolytes for a nonaqueous secondary battery obtained in Example 12 and Comparative Example 2, the MoS_{5.7} powder obtained in Synthesis Example 2 was used as a cathode active material.

Experimental electrochemical cells (lithium secondary battery) were produced according to the following method, and constant-current charge and discharge measurements were performed in 100 cycles at 25° C. for at a charge-discharge rate of 0.1C (1C=747 mAh/g) at a voltage within the range of 2.6 V to 1.9 V with a down-time of 10 minutes between cycles.

The method for producing experimental electrochemical cells was the following: first, a working electrode (cathode) was produced by adding 1 mg of Ketjen black and 1 mg of polytetrafluoroethylene (PTFE) (binder) to 10 mg of the VS₄ powder obtained in Synthesis Example 1 and mixing these components in a mortar for 8 minutes, followed by pasting the resulting mixture to an aluminum mesh.

For the counter-electrode (anode), lithium metal was used.

For the separator, polypropylene was used.

Table 1 shows the results of charge/discharge cycle performance (capacity retention (%) after the 100th cycles).

The capacity retention refers to the ratio of the capacity measured after 100 cycles to the capacity at the start of a cycle test (the first cycle), which is defined as 100. The higher the capacity retention, the better the battery life characteristics.

TABLE 1
Table 1

| | Initial Internal Resistance (Ω) and Capacity Retention (%) | | | | | | |
|---|---|---|---|---|---|---|---|
| | | | | | | | Capacity |
| | | | | | | Initial | Retention |
| | | | | Amount of | | Internal | after 100 |
| | Active | TFSI:Solvent | | Additive | | Resistance | Cycles |
| | Material | (Molar Ratio) | Solvent | (%) | Additive | (Ω) | (%) |
| Example 1 | VS4 | 1:2 | EMC | 2.5 | FEC | 0.122 | 83.8 |
| Example 2 | VS4 | 1:2 | EMC | 5 | FEC | 0.103 | 96.3 |
| Example 3 | VS4 | 1:2 | EMC | 10 | FEC | 0.094 | 96.9 |
| Example 4 | VS4 | 1:2 | EMC | 2.5 | VC | 0.114 | 77.8 |
| Example 5 | VS4 | 1:2 | EMC | 5 | VC | 0.109 | 78.8 |
| Example 6 | VS4 | 1:2 | EMC | 10 | VC | 0.146 | 81.9 |
| Example 7 | VS4 | 1:3 | EMC | 10 | FEC | 0.082 | 93.8 |
| Example 8 | VS4 | 1:4 | EMC | 10 | FEC | 0.099 | 90.3 |
| Example 9 | VS4 | 1:2 | DMC | 10 | FEC | 0.082 | 93.1 |
| Example 10 | VS4 | 1:2 | DEC | 10 | FEC | 0.099 | 97.1 |
| Example 11 | VS4 | 1:2 | EMC | 5 | VC | 0.091 | 75.3 |
| | | | | 5 | FEC | | |
| Example 12 | MoS5.7 | 1:3 | EMC | 10 | FEC | 0.173 | 45.1 |
| Comparative | VS4 | 1:2 | EMC | — | — | 0.183 | 14.0 |
| Example 1 | | | | | | | |
| Comparative | MoS5.7 | 1:3 | EMC | — | — | 0.256 | 2.0 |
| Example 2 | | | | | | | |

The initial internal resistance is not determined based on the threshold value.

In the stage before the charge-and-discharge cycles, when VS₄ was used as an active material, Examples 1 to 11 of the present invention exhibited resistance lower than Comparative Example 1 by 25% or more. This suggests that Examples 1 to 11 of the present invention can attain a battery system with high energy efficiency because electrical energy provided for charging is not wasted due to exothermic heat of resistance.

When MoS_{5.7} was used as an active material, Example 12, in which the present invention was applied, also exhibited resistance lower than the internal resistance demonstrated in Comparative Example 2 by 25% or more. This suggests that Example 12, in which the present invention was applied, can attain a battery system with high energy efficiency in the same manner as with the use of VS₄.

The capacity retention is not determined based on the threshold value.

When VS₄ was used as an active material, Examples 1 to 11 of the present invention exhibited a capacity retention higher than Comparative Example 1 by 50% or more. This suggests that Examples 1 to 11 of the present invention can attain a battery system with high energy efficiency and excellent life characteristics.

When MoS_{5.7} was used as an active material as well, Example 12, in which the present invention was applied, exhibited a capacity retention higher than Comparative Example 2 by 40% or more. This suggests that Example 12, in which the present invention was applied, can attain a battery system with high energy efficiency and excellent life characteristics.

### INDUSTRIAL APPLICABILITY

The electrolyte for a nonaqueous secondary battery and the nonaqueous secondary battery containing the electrolyte according to the present invention have various known applications. Specific examples include laptop computers, cellular phones, electric vehicles, power sources for load leveling, and power sources for natural energy storage.

1. An electrolyte for a nonaqueous secondary battery,
the nonaqueous secondary battery comprising a lithium-free transition metal sulfide as a cathode active material,
the electrolyte comprising an organic solvent containing a chain carbonate compound,
lithium bis(trifluoromethanesulfonyl)imide (LiTFSI), and
an additive.

2. The electrolyte for a nonaqueous secondary battery according to claim 1, wherein the additive is at least one member selected from the group consisting of vinylene carbonate (VC) and fluoroethylene carbonate (FEC).

3. The electrolyte for a nonaqueous secondary battery according to claim 1, wherein the content of the chain carbonate compound is two to four times the content of the lithium bis(trifluoromethanesulfonyl)imide (LiTFSI) on a molar ratio basis.

4. The electrolyte for a nonaqueous secondary battery according to claim 1, wherein the content of the additive is 2.5 wt % to 10 wt % based on the total amount of the electrolyte taken as 100 wt %.

5. The electrolyte for a nonaqueous secondary battery according to claim 1, wherein the chain carbonate compound is at least one member selected from the group consisting of dimethyl carbonate (DMC), diethyl carbonate (DEC), and ethyl methyl carbonate (EMC).

6. The electrolyte for a nonaqueous secondary battery according to claim 1, wherein the lithium-free transition metal sulfide is at least one member selected from the group consisting of vanadium sulfides and molybdenum sulfides.

7. A nonaqueous secondary battery comprising the electrolyte for a nonaqueous secondary battery of claim 1.

8. The nonaqueous secondary battery according to claim 7, which is a lithium-ion secondary battery.
